(19) United States
(12) Patent Application Publication
(10) Pub. No.: US 2004/0064833 A1
(43) Pub. Date: Apr. 1, 2004

(54) Methods and apparatus for an advertisement display service using metadata

(76) Inventors: Seok-Pil Lee, Seoul (KR); We Duke Cho, Seongnam-si (KR)

Correspondence Address: GROSSMAN & FLIGHT LLC, Suite 4220, 20 North Wacker Drive, Chicago, IL, 60606-6357, US

(21) Appl. No.: 10/664,660

(22) Filed: Sep. 19, 2003

(30) Foreign Application Priority Data
Aug. 10, 2002 (KR) 10-2002-0061209

(51) Int. Cl. G06F 3/00

(52) U.S. Cl. 725/42

(57) ABSTRACT

Methods and apparatus for an advertisement display service using metadata is disclosed. The method for providing a selective advertisement display comprises constructing a user's preference for television programs; analyzing and filtering metadata of advertisements based on said user's preference; storing the selected advertisements on digital television; analyzing metadata of a program viewed by the user when the user watches television; matching the metadata of the program with the metadata of advertisements stored; and providing the most related advertisement in the form of banner, based on the result of the matching. Thus, the present system can provide a targeting service corresponding to each user's tastes without leaking user's personal information, by storing advertisements corresponding to the user's tastes beforehand and, subsequently, providing the advertisements related to a program viewed by the user in the form of a banner.

### PRIORITY CLAIM

This application claims priority from Korean Patent Application No. 10-2002-0061209 filed on Oct. 8, 2002.

### TECHNICAL FIELD

The present disclosure relates to methods and apparatus for an advertisement display service using metadata, and more particularly, to methods and apparatus of advertisement display which shows advertisements associated with a program watched by viewers, after analyzing and filtering advertisements using metadata and storing the selected advertisements on a digital television beforehand.

### BACKGROUND

In the prior art, there is a method of providing advertisements related to a service for consumers, after analyzing the consumers' tastes beforehand. An example of such method is disclosed in Korean Patent Publication No. 2000-0112711. In addition, a method exists that allows a consumer to directly and selectively download advertisements and other content. Examples of this method are disclosed in U.S. Pat. Nos. 5,532,735 and 5,838,314.

However, these selective advertisement display services have a problem in that broadcasting stations and/or service providers have to be fully aware of information about consumers' tastes in order to target the advertisements. As a result, personal information can be disseminated causing privacy-related problems.

### BRIEF DESCRIPTION OF THE DRAWINGS

FIG. 1 is a block diagram of an example service system illustrating an environment of use for the disclosed system.

FIG. 2 is an example of an XML file of metadata for a television program.

### DETAILED DESCRIPTION

In general, the system described herein provides methods and apparatus for delivering advertisements corresponding to a user's tastes without leaking personal information. The advertisements are preselected based on the user's tastes and are prestored locally on a digital television. Subsequently, the advertisements are displayed in the form of banners and are related to programs viewed by the user.

In an embodiment, there is provided a method and apparatus for advertisement display service, which delivers advertisements corresponding to programs that a user views through a digital television 1 having a local storage 4, a XML parser 2 and a matching engine 3.

A method for delivering selective advertisements according to the present disclosure comprises: (i) constructing a user's preference for television programs; (ii) analyzing and filtering metadata of advertisements based on said user's preference; (iii) storing the selected advertisements on a digital television; (iv) analyzing metadata of a program viewed by the user when the user watches television; (v) matching the metadata of the program with the metadata of advertisements stored; and (vi) providing the most related advertisement in the form of a banner, based on the result of the matching.

It is to be understood that both the foregoing general description and the following detailed description are exemplary and explanatory and are intended to provide further explanation of the invention as claimed. Reference will now be made in detail to example embodiments as illustrated in the accompanying drawings.

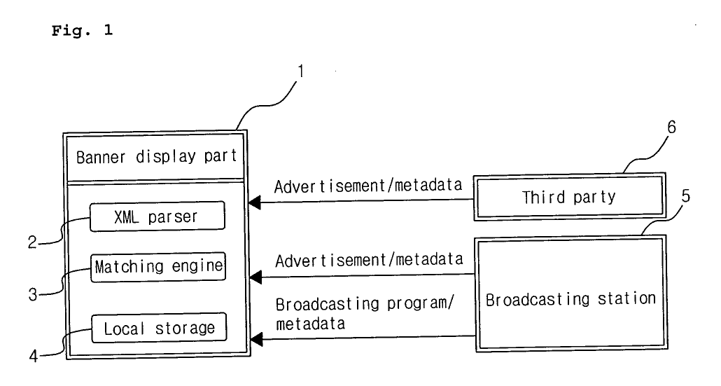

Referring to FIG. 1, a digital television system 1 comprises modules such as a local storage 4 which stores advertisements corresponding to viewer's tastes, TV programs recorded and information about a viewer's preference, an XML parser 2 to interpret metadata, a matching engine 3, and a banner display part. The XML parser 2 plays a role to analyze, search, and extract sentences, and includes an object-based Document Objective Model (hereinafter referred to as “DOM”) parser and an event-driven Simple API for XML (hereinafter referred to as “SAX”) parser. A third party 6 means an information provider such as Internet Service Provider (hereinafter referred to as “ISP”). The third party provides advertisements and associated metadata together with broadcasting stations. In addition, the system uses metadata established in the form of XML, as defined in accordance with TV Anytime Forum and MPEG-7.

A method for selectively providing advertisements may be embodied in one or more software programs which are stored in one or more memories and executed by one or more processors in a well known manner. However, some or all of the process may be performed manually and/or by other devices. In addition, a person of ordinary skill in the art will readily appreciate that many methods of performing the process may be used. For example, the order of many of the operations may be altered, the function of one or more operations may be changed, operations may be combined, and/or operations may be eliminated.

An example method for selectively providing advertisements using the devices described above comprises: (i) analyzing a viewer's preference for television programs and storing data associated with those preferences on the local storage device 4. For example, the viewer's preferences may include data associated with TV stars, genres, and broadcasting stations which the viewer likes. The viewer's preferences may be obtained directly by receiving inputs indicating the preferences from the viewer and/or indirectly by observing habits of the viewer. For example, the viewer may indicate he likes wine.

In addition, the method comprises (ii) analyzing and filtering metadata of advertisements based on the viewer's preference, and selectively storing only the advertisements corresponding to the viewer's tastes on the local storage 4. The metadata of the advertisements may be provided by the third party 6 and/or the broadcasting station 5 and is interpreted by the XML parser 2. For example, the metadata may include the word “wine.”

In addition, the method comprises (iii) interpreting metadata of a program viewed by a user by means of the XML parser when the user views the program; (iv) matching the metadata of advertisements stored with the metadata of the program by means of the matching engine 3; and (v) displaying the advertisement most related to the program viewed by the user in the form of a banner, based on the results of the matching.

For example, if a user likes wine, the digital television system stores advertisements about wine beforehand, and displays the wine advertisement stored when wine appears in a TV program or the scene of eating steak in a restaurant is shown as determined by interpreting the metadata of the TV program.

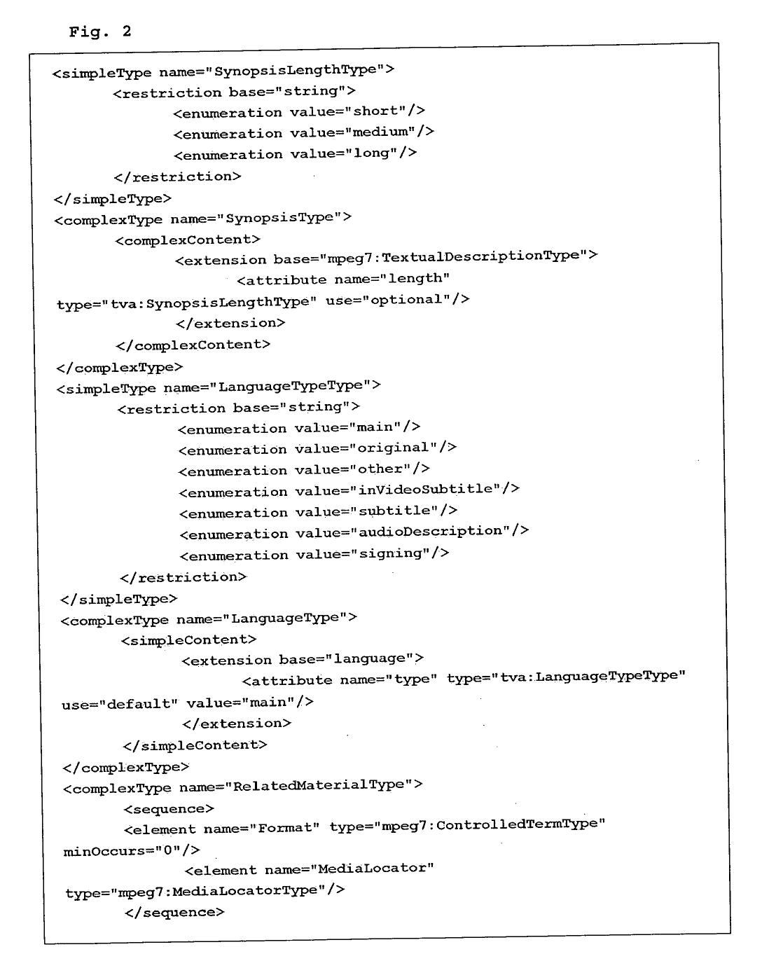

FIG. 2 shows an example of an XML file for a TV program which includes metadata. Accordingly, the methods and apparatus for an advertisement display service using metadata can maximize advertising effects by storing advertisements corresponding to a user's tastes beforehand and, subsequently, providing the advertisements related to a program viewed by the user in the form of a banner when the user views the program. Moreover, the methods and apparatus for an advertisement display service using metadata can provide a targeting service corresponding to each user's tastes without leaking user's personal information.

Although the above discloses example systems including, among other components, software executed on hardware, it should be noted that such systems are merely illustrative and should not be considered as limiting. For example, it is contemplated that any or all of the disclosed hardware and software components could be embodied exclusively in dedicated hardware, exclusively in software, exclusively in firmware or in some combination of hardware, firmware and/or software.

The foregoing embodiments are merely exemplary and are not to be construed as limiting. The present teachings can be readily applied to other types of apparatuses. The description herein is intended to be illustrative, and not to limit the scope of the claims. Many alternatives, modifications and variations will be apparent to those skilled in the art. This patent covers all apparatuses, methods and articles of manufacture fairly falling within the scope of the appended claims either literally or under the doctrine of equivalents.

What is claimed is:

1. A method of displaying an advertisement using metadata comprising:
constructing a user's preference for television programs and storing the user's preference on a local storage device;
analyzing and filtering first metadata associated with an advertisement based on the user's preference and storing the advertisement selectively corresponding to the user's preference on the local storage;
displaying a television program;
interpreting second metadata associated with the television program;
matching the second metadata associated with the television program with the first metadata associated with the advertisement; and
displaying the advertisement in a banner form in response to the matching.

2. A method as defined in claim 1, wherein the user's preference includes at least one of a TV star, a genre, and a broadcasting station.

3. A method as defined in claim 1, wherein the first metadata associated with the advertisement is provided by a third party, the third party including at least one of an internet service provider and a broadcasting station.

4. A method as defined in claim 1, wherein analyzing and filtering first metadata associated with the advertisement based on the user's preference comprises an extensible markup language (XML) parser interpreting the first metadata associated with the advertisement.

5. A method as defined in claim 4, wherein the XML parser includes a document objective model (DOM) parser.

6. A method as defined in claim 4, wherein the XML parser includes a simple application programming interface (API) for XML (SAX) parser.

7. An apparatus for providing a selective advertisement display service using metadata, the apparatus comprising:
a digital television display;
a local storage device operatively coupled to the digital television display, the local storage device storing a user preference and an advertisement selectively corresponding to the user preference;
an extensible markup language (XML) parser operatively coupled to the digital television display; and
a matching engine operatively coupled to the digital television display.

8. An apparatus as defined in claim 7, wherein the XML parser interprets metadata associated with a television program.

9. An apparatus as defined in claim 7, wherein the matching engine matches second metadata associated with a television program with first metadata associated with the advertisement.

10. An apparatus as defined in claim 7, wherein the digital television display displays the advertisement in a banner form.

11. An apparatus as defined in claim 7, wherein the local storage device stores a recorded television program.
